(19) United States
(12) Patent Application Publication
(10) Pub. No.: US 2010/0199859 A1
(43) Pub. Date: Aug. 12, 2010

(54) ROASTING OVEN STRUCTURE AND HEIGHTENED STRUCTURAL IMPROVEMENT OF ITS OVEN WALL

(76) Inventor: Kuei-Tang CHANG, Banchiau City (TW)

Correspondence Address: HDLS Patent & Trademark Services, P.O. BOX 220746, CHANTILLY, VA, 20153-0746, US

(21) Appl. No.: 12/369,846

(22) Filed: Feb. 12, 2009

(51) Int. Cl. A47J 37/00

(52) U.S. Cl. 99/449

(57) ABSTRACT

A roasting oven includes an oven body, an oven lid and a heightened oven wall shown as a ring shape and placed on the oven body, while the oven lid covers the heightened oven wall. The heightened oven wall is assembled by plural sections of wall parts with a capability of being dismantled. The heightened oven wall capable of being disassembled is assembled by connecting each section of wall part together, making the heightened oven wall disassembled when not used to reduce the occupied space by disassembling the plural sections of wall parts, thereby, facilitating the accommodation, the package and the transportation of the product.

### BACKGROUND OF THE INVENTION

1. Field of the Invention

The present invention in general relates to a product of home appliance, in particular, to a roasting oven for cooking food by a thermal flow manner and to a heightened structure of its oven wall.

2. Description of Prior Art

Accordingly, a prior baking oven, mainly for baking the Western-style pastry such as bread, cake and biscuit, is a kind of baking oven that cooks food by means of high temperature. However, following daily emphasis by people on eating and drinking, manners of cooking food also increase, due to the requirement of dainty by people. Besides baking the aforementioned foods, current baking oven also needs to roast meat or food such as chicken occupying large volume and space.

However, the space of common roasting oven used in home is quite limited in terms of space for accommodating food so, when baking or roasting the meat or food such as chicken occupying large volume or space, an oven wall of ring shape has to be additionally arranged onto the original roasting oven. After heightening the oven wall of the original roasting oven, although the problem of the limitation of the interior space can be solved, the prior oven wall of ring type for increasing the interior space of the roasting oven is a rigid structure that is integrally made and unable to be dismantled or folded, so many problems such as the occupation of large space when not used are incurred to the user. In addition, for the manufacturer, when the products of roasting oven are packaged or transported, the derived shortcomings of the occupation of large space are also incurred, due to the increasing space in the interior of the roasting oven.

Therefore, how to improve and solve the aforementioned problems is an issue intended to be addressed by the inventor.

Accordingly, after a substantially devoted study, in cooperation with the application of relatively academic principles, the inventor has finally proposed the present invention that is designed reasonably to possess the capability to improve the drawbacks of the prior arts significantly.

### SUMMARY OF THE INVENTION

The invention is mainly to provide a roasting oven structure and a heightened structural improvement of its oven wall, in which an oven wall of ring type is adapted for increasing the interior space of the roasting oven, constituting an assembling manner capable of dismantlement. In other words, the oven wall can be disassembled to thereby reduce the space occupation when not used, so it is convenient for the accommodation, the package and the transportation of the product, effectively solving the aforementioned problems and shortcomings.

Secondly, the invention is to provide a roasting oven structure, which includes an oven body, an oven lid and a heightened oven wall shown as a ring shape and placed on the oven body, while the oven lid covers the heightened oven wall. According to the invention, the heightened oven wall is assembled by plural sections of wall parts capable of being dismantled. The heightened oven wall capable of being disassembled is assembled by connecting each section of wall part together, thereby, the aforementioned objectives being achieved effectively.

Thirdly, the invention is to provide a heightened structural improvement of the oven wall of a roasting oven, which is assembled between an oven body and an oven lid, and which is an enclosure of oven wall shown as a ring shape and arranged by connecting plural sections of wall parts capable of being dismantled. Since the heightened oven wall is assembled by each section of wall part and is capable of being dismantled, the aforementioned objective is thereby achieved.

Compared to the prior arts, since the heightened oven wall of the invention is assembled with a capability of being dismantled, for the user, it is easy to accommodate the product when not used; on the other hand, for the manufacturer, it is also convenient for packaging and transporting the product to further reduce the unnecessary storing space and transporting cost.

### BRIEF DESCRIPTION OF DRAWING

The features of the invention believed to be novel are set forth with particularity in the appended claims. The invention itself, however, may be best understood by reference to the following detailed description of the invention, which describes several exemplary embodiments of the invention, taken in conjunction with the accompanying drawings, in which:

FIG. 1 is a perspective explosive illustration of the invention;

FIG. 2 is a perspective assembled illustration of the invention;

FIG. 3 is an explosive illustration of both the oven body and the heightened oven wall of the invention;

FIG. 4 is an assembled illustration of both the oven body and the heightened oven wall of the invention;

FIG. 5 is an explosive illustration of the first and second wall parts of the invention;

FIG. 6 is a detailed view of an enlargement of the “A” part in FIG. 5;

FIG. 7 is a plane top view of the heightened oven wall of the invention; and

FIG. 8 is a detailed view of an enlargement of the “A” part in FIG. 7.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

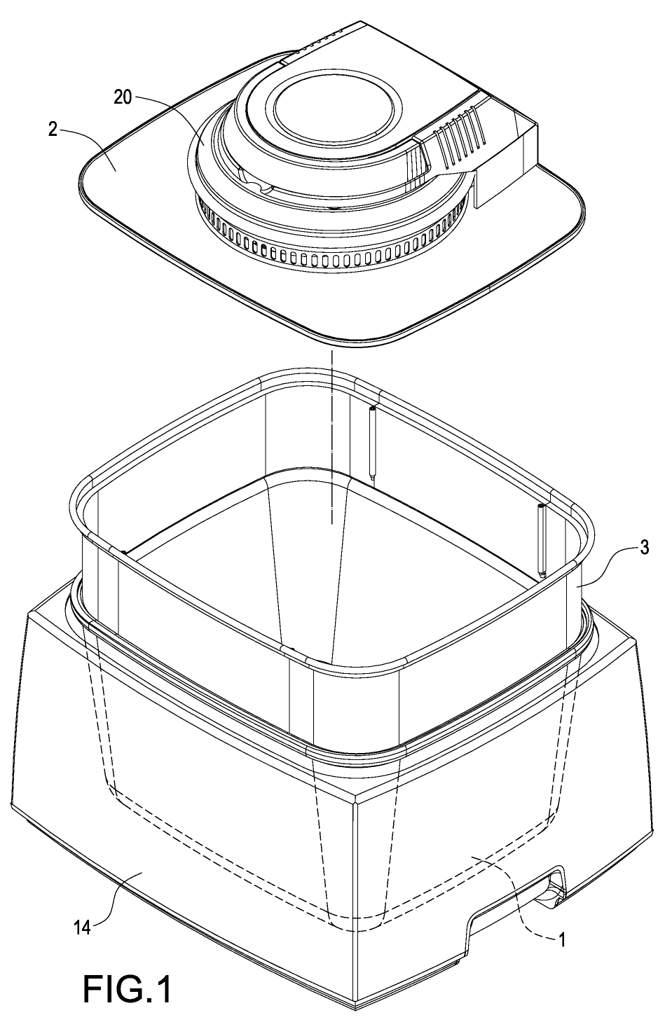

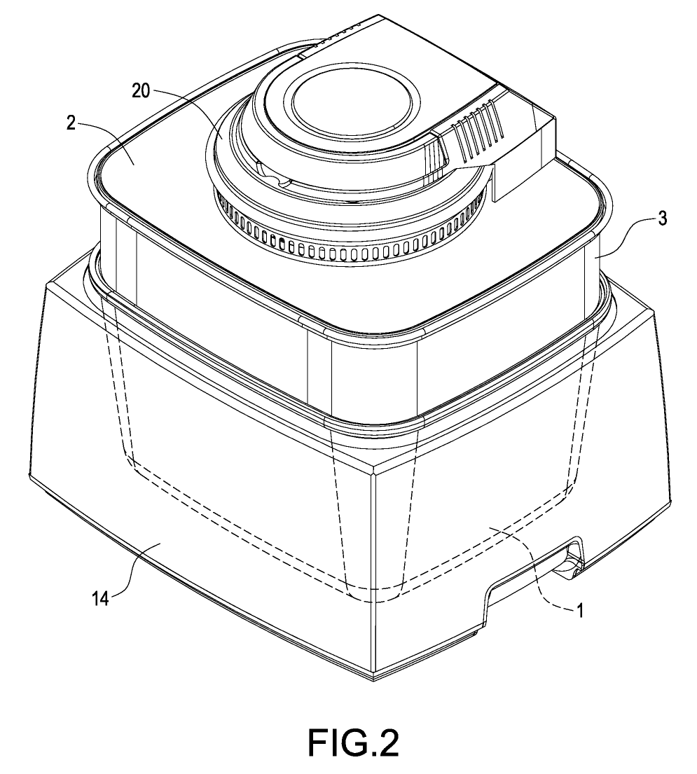

Please refer to FIG. 1 and FIG. 2, which respectively are a perspective explosive illustration and a perspective assembled illustration of the invention. The invention is mainly to provide a roasting oven structure and a heightened structural improvement of its oven wall, in which the roasting oven structure includes an oven body 1, an oven lid 2 and a heightened oven wall 3. By assembling the heightened oven wall 3 between the oven body 1 and the oven lid 2, the accommodating space loadable by the oven body 1 increases and the roasting oven can bake and roast with larger and more food ingredients.

The oven body 1, made of a material with high temperature resistance, is constituted by a ring wall 10 with continuous enclosure and a bottom wall 11 closely connected to the bottom part of the ring wall 10, such that an accommodating space 12 is formed in the oven body 1 for loading the food or ingredients to be cooked.

The oven lid 2 can be optionally arranged by covering onto the oven body 1 or the heightened oven wall 3. In the meantime, a heating unit 20 capable of roasting or baking function can be placed onto the oven lid 2 to generate a thermal flow for undergoing a baking or roasting task to the food ingredients intended to be cooked in the oven body 1. When the oven lid 2 corresponds to the oven body 1, on the upper edge of the ring wall 10 of the oven body 1, a ring flange 13 turned to the outside is formed. The form enclosed by the inner edge face 130 of the ring flange 13 is conformable to the form of the outer edge of the oven lid 2 and is tightly matched therewith in a way, such that the closed space formed in the oven body 1 can prevent hot gas from releasing out. In addition, an oven seat 14 can be further arranged under the oven body 1 to support the oven body 1 with protecting functions of stable installation and thermal insulation.

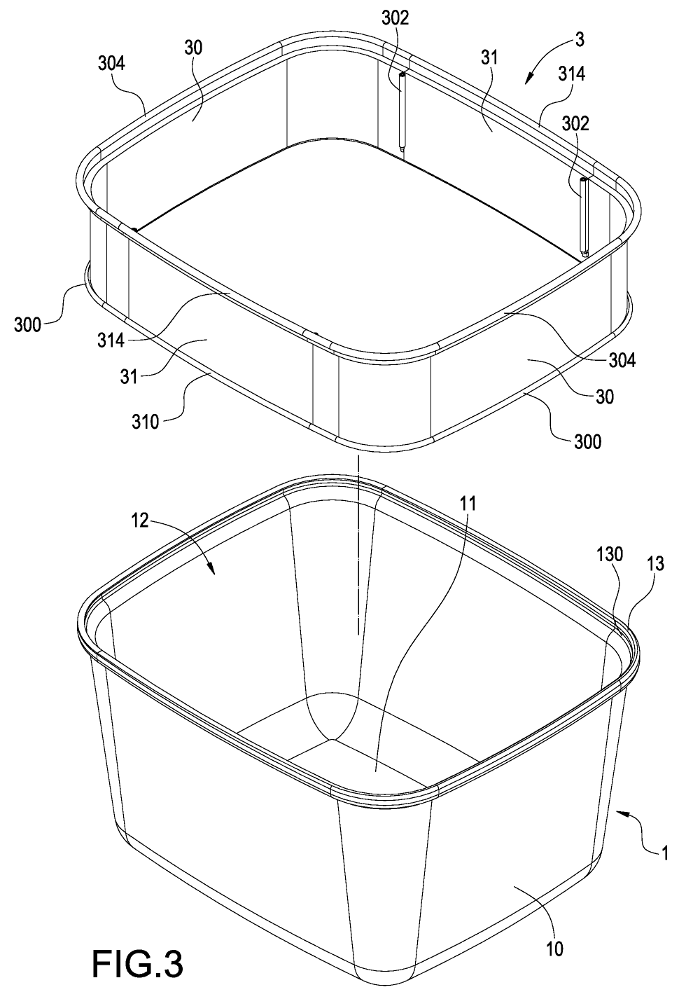

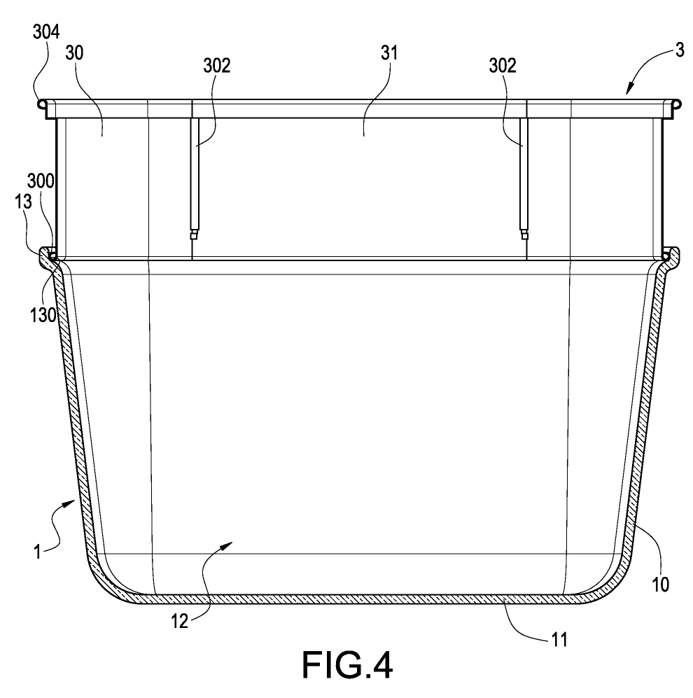

When the food ingredients for the oven body 1 are too large or too many to be cooked, the heightened oven wall 3 can increase the space and the capacity loadable by the oven body 1. Please refer to FIG. 3 and FIG. 4 together. When the heightened oven wall 3 is placed on the oven body 1, the oven lid 2 then covers the heightened oven wall 3 correspondingly. The heightened oven wall 3 is at least constituted by plural sections of wall parts 30, 31, which can be assembled with a capability of being dismantled, such that an oven wall structure shown as a ring enclosure is thereby formed. In the embodiments proposed by the invention, the wall parts include two first wall parts 30 and two second wall parts 31, in which the cross-sectional profile of the first wall part 30 is shown as a “U” letter. Both the first wall parts 30 are arranged by corresponding to each other and are connected by both the second wall parts 31 to constitute a form conformable to the form enclosed by the inner edge face 130 of the ring flange 13 of the oven body 1. In the meantime, tightly connecting bottom edges 300, 310 turned to the outside are formed at the lower edges of the first and second wall parts 30, 31 and can be tightly abutted onto the inner edge face 130 along the inner peripheral of the ring flange 13. Thereby, the heightened oven wall 3 can be placed onto the oven body 1 tightly to increase the space and the capacity loadable by the oven body 1.

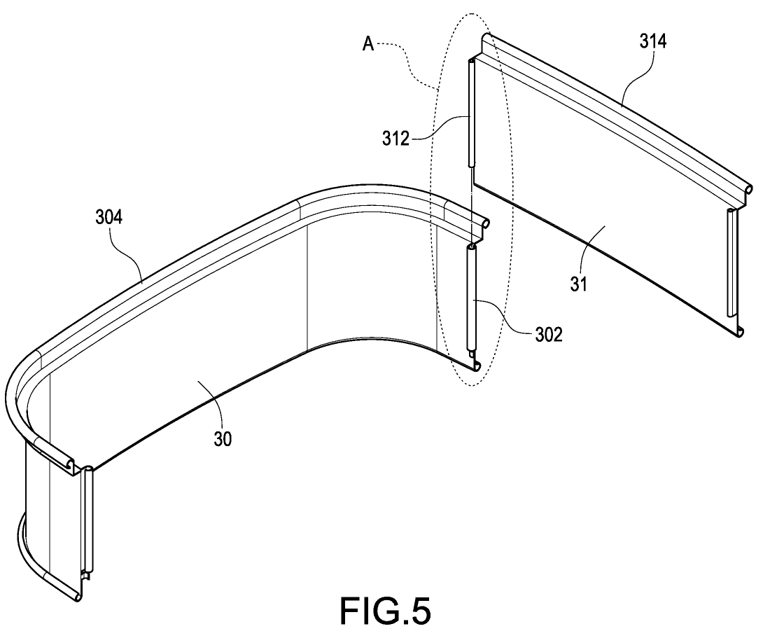

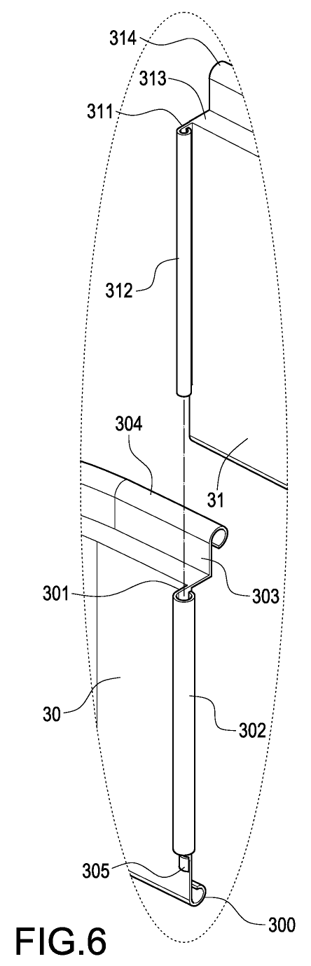

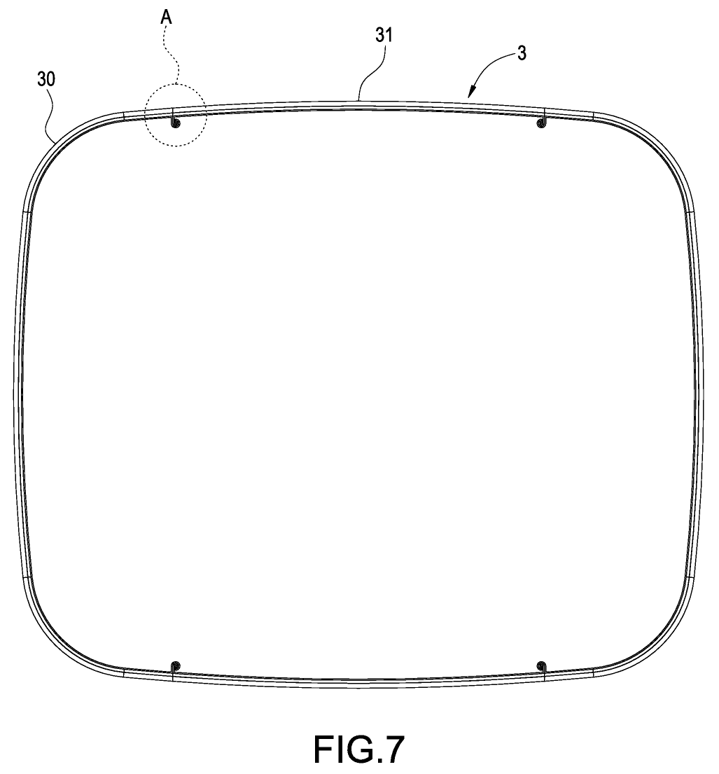

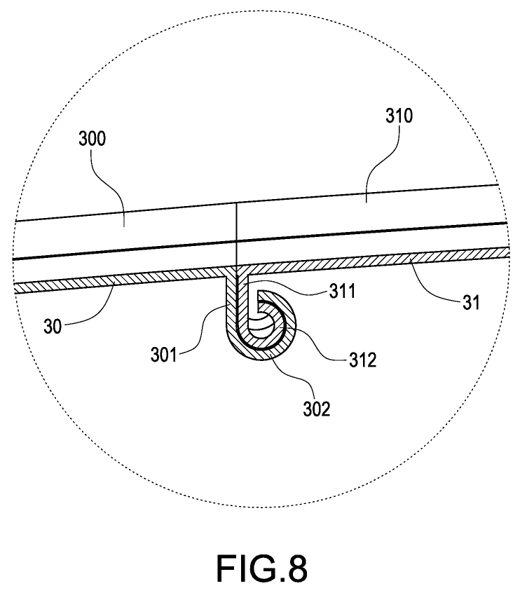

As shown in FIG. 5 and FIG. 6, with respect to the assembly between each pair of the first and second wall parts 30, 31 of the heightened oven wall 3, two vertical plates 301, 311 extended inwardly are arranged at two adjacent sides of the wall parts 30, 31 to be connected together. Rolled-and-fitted plates 302, 312 extended from the ends of the vertical plates 301, 311 are shown as cured reel shapes. Any pair of the rolled-and-fitted plates 302, 312 at two adjacent sides of the wall parts 30, 31 to be connected together is fitted by enveloping the inside with the outside, such that each pair of oven walls 30, 31 can be assembled with a capability of being dismantled. In the embodiments proposed by the invention, the radian formed by the rolled-and-fitted plate 302 of the first wall part 30 is larger than that of the rolled-and-fitted plate 312 of the second wall part 31, while the outer arc of the rolled-and-fitted plate 312 of the second wall part 31 is in cooperation with the inner arc of the rolled-and-fitted plate 302 of the first wall part 30, such that the rolled-and-fitted plate 312 of the second wall part 31 can be placed into the rolled-and-fitted plate 302 of the first wall part 301 from top to bottom, as shown in FIG. 7 and FIG. 8. By the fitting cooperation between the rolled-and-fitted plates 302, 312 of the first and second wall parts 30, 31, the heightened oven wall 3 can be assembled with a capability of being dismantled. Furthermore, a stop plate 305 can be further arranged at lower end of the rolled-and-fitted plate 302 of the first wall part 30 such that, after the rolled-and-fitted plate 312 of the second wall part 31 is fitted therein and abutted against its end, it can prevent the rolled-and-fitted plate 312 of the second wall part 31 from sliding downwardly continuously.

In addition, in order to make the oven lid 2 closely covered on the heightened oven wall 3, flanges 304, 314 turned to outside are also formed on the upper edges of the first and second wall parts 30, 31. When the first and second wall parts 30, 31 are assembled to form the heightened oven wall 3, the flanges 304, 314 of the first and second wall parts 30, 31 can just constitute a ring shape, such that the form enclosed by the inner edge faces 303, 313 of the flanges 304, 314 of the first and second wall parts 30, 31 is conformable to the outer edge form of the oven lid 20 and is tightly matched therewith to make the oven lid 2 able to be tightly covered on the heightened oven wall 3.

Summarizing aforementioned description, the invention is an indispensably novel structure for a compressor indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A roasting oven structure, including:
an oven body (1);
an oven lid (2); and
a heightened oven wall (3), which is shown as an oven wall with a ring enclosure and is placed on the oven body (1), while the oven lid (2) then covers on the heightened oven wall (3);
wherein the heightened oven wall (3) is assembled by plural sections of wall parts (30, 31) with a capability of being dismantled.

2. The roasting oven structure according to claim 1, wherein the oven body (1) is further arranged an oven seat (14).

3. The roasting oven structure according to claim 1, wherein the oven body (1) is comprised of a ring wall (10) formed by a continuous enclosure and a bottom wall (11) closed by and connected to a bottom part of the ring wall (10).

4. The roasting oven structure according to claim 3, wherein an upper edge of the ring wall (10) of the oven body (1) is formed a ring flange (13) turned to an outside, and a lower edge of each wall parts (30, 31), which is formed a tightly connecting bottom edge (310) turned to an outside, and constitutes a form conformable to another form enclosed by an inner edge face (130) of the ring flange (13) and able to be closely abutted thereon.

5. The roasting oven structure according to claim 4, wherein the wall parts include two first wall parts (30) and two second wall parts (31), and a cross-sectional profile of both the first wall parts (30) is shown as a “U” letter, and both the first wall parts (30) are arranged corresponding to each other and are connected by both the second wall parts (31) to constitute the heightened oven wall (3).

6. The roasting oven structure according to claim 5, wherein each of the first and second wall parts (30, 31) is arranged a vertical plate (301, 311) extended inwardly at each adjacently connecting sides, and a rolled-and-fitted plate (302, 312) is extended from each end of the vertical plate (301, 311), and the rolled-and-fitted plates (302, 312) of any two adjacent wall parts (30, 31) are fitted in cooperation with each other by an outside-enveloping-inside manner.

7. The roasting oven structure according to claim 6, wherein a radian formed by the rolled-and-fitted plate (302) of the first wall part (30) is larger than another radian formed by the rolled-and-fitted plate (312) of the second wall part (31), and an outer arc of the rolled-and-fitted plate (312) of the second wall part (31) is just in cooperation with an inner arc of the rolled-and-fitted plate (302) of the first wall part (30).

8. The roasting oven structure according to claim 6, wherein a stop plate (305) is arranged at a lower end of the rolled-and-fitted plate (302) of the first wall part (30) to abut against a lower end of the rolled-and-fitted plate (312) of the second wall part (31).

9. The roasting oven structure according to claim 1, wherein the wall parts include two first wall parts (30) and two second wall parts (31), and a cross-sectional profile of both the first wall parts (30) is shown as a “U” letter, and both the first wall parts (30) are arranged corresponding to each other and are connected by both the second wall parts (31) to constitute the heightened oven wall (3).

10. The roasting oven structure according to claim 1, wherein an upper edge of each wall parts (30, 31) is formed a flange (304, 314) turned to an outside, and a form enclosed by inner edge faces of the flanges (304, 314) is conformable to an outer edge form of the oven lid (2) for providing the oven lid (2) able to be closely covered on the heightened oven wall (3).

11. The roasting oven structure according to claim 1, wherein the oven walls (30, 31) assembled with a capability of being dismantled means that each of the first and second wall parts (30, 31) is arranged a vertical plate (301, 311) extended inwardly at each of adjacently connecting sides, and a rolled-and-fitted plate (302, 312) is extended from each end of the vertical plates (301, 311), and the rolled-and-fitted plates (302, 312) of any two adjacent wall parts (30, 31) are fitted in cooperation with each other by an outside-enveloping-inside manner.

12. An heightened structural improvement of oven wall of roasting oven, being assembled between an oven body (1) an oven lid (2); the heightened oven structure being an oven wall shown as a ring enclosure and being assembled by plural sections of wall parts (30, 31) with a capability of being dismantled.

13. The heightened structural improvement of oven wall of roasting oven according to claim 12, wherein the wall parts include two first wall parts (30) and two second wall parts (31), and a cross-sectional profile of both the first wall parts (30) is shown as a “U” letter, and both the first wall parts (30) are arranged corresponding to each other and are connected by both the second wall parts (31) to constitute the heightened oven wall (3).

14. The heightened structural improvement of oven wall of roasting oven according to claim 13, wherein each of the first and second wall parts (30, 31) is arranged a vertical plate (301, 311) extended inwardly at each adjacently connecting sides, and a rolled-and-fitted plate (302, 312) is extended from each end of the vertical plate (301, 311), and the rolled-and-fitted plates (302, 312) of any two adjacent wall parts (30, 31) are fitted in cooperation with each other by an outside-enveloping-inside manner.

15. The heightened structural improvement of oven wall of roasting oven according to claim 14, wherein a radian formed by the rolled-and-fitted plate (302) of the first wall part (30) is larger than another radian formed by the rolled-and-fitted plate (312) of the second wall part (31), and an outer arc of the rolled-and-fitted plate (312) of the second wall part (31) is just in cooperation with an inner arc of the rolled-and-fitted plate (302) of the first wall part (30).

16. The heightened structural improvement of oven wall of roasting oven according to claim 14, wherein a stop plate (305) is arranged at a lower end of the rolled-and-fitted plate (302) of the first wall part (30) to abut against a lower end of the rolled-and-fitted plate (312) of the second wall part (31).

17. The heightened structural improvement of oven wall of roasting oven according to claim 12, wherein the oven walls (30, 31) assembled with a capability of being dismantled manner means that each of the first and second wall parts (30, 31) is arranged a vertical plate (301, 311) extended inwardly at each of adjacently connecting sides, and a rolled-and-fitted plate (302, 312) is extended from each end of the vertical plates (301, 311), and the rolled-and-fitted plates (302, 312) of any two adjacent wall parts (30, 31) are fitted in cooperation with each other by an outside-enveloping-inside manner.
